(19) United States
(12) Patent Application Publication
(10) Pub. No.: US 2014/0028638 A1
(43) Pub. Date: Jan. 30, 2014

(54) DISPLAY PANEL

(71) Applicant: Chun-Ho Tsao, Taoyuan County (TW)

(72) Inventor: Chun-Ho Tsao, Taoyuan County (TW)

(73) Assignee: CHUNGHWA PICTURE TUBES, LTD., Taoyuan (TW)

(21) Appl. No.: 13/620,729

(22) Filed: Sep. 15, 2012

(30) Foreign Application Priority Data
Jul. 26, 2012 (TW) 101127067

(51) Int. Cl. G06F 3/038

(52) U.S. Cl. 345/204

(57) ABSTRACT

A display panel including a pixel array substrate, an opposite substrate and a display medium is provided. The pixel array substrate includes a plate, data lines, scan lines, and pixel units. The data lines extend along a column direction and are arranged along a row direction. The scan lines extend along the row direction and are arranged along the column direction. The first data line is electrically connected with pixel units on the second column. The second data line is electrically connected with pixel units on the first and third columns. The third data line is electrically connected with pixel units on the fourth and sixth columns. The first scan line is electrically connected with pixel units on the first, fourth and fifth rows of the first column. The second scan line is electrically connected with pixel units on the second, third, sixth and seventh rows of the first column.

### CROSS-REFERENCE TO RELATED APPLICATION

This application claims the priority benefit of Taiwan application serial no. 101127067, filed on Jul. 26, 2012. The entirety of the above-mentioned patent application is hereby incorporated by reference herein and made a part of this specification.

### BACKGROUND OF THE INVENTION

1. Field of the Invention

The invention is directed to a display panel and more particularly, to a display panel with high display quality and lower power consumption.

2. Description of the Related Art

With advantages of being thinner and lighter, power-saving and low-radiation, flat panel displays (FPD) have become the mainstream display products in the display industry. In recent years that the display technique is highly developed, beside high display quality, the FPDs are required to have advantages of low power consumption to be used in mobile electronic devices, such as smart phones, tablet computers or notebook (NB).

Generally, the typical FPD is driven by adopting one of the methods, such as column inversion, row inversion, frame inversion or dot inversion. Among the aforementioned methods, the column inversion method has the lowest power consumption. However, a problem of cross talk easily occurs in the FPD driven by the column inversion method, which results in bad display effects in the FPD. The FPD driven by the dot inversion method has better display quality, where problems such as cross talk or flicking seldom happen. However, the FPD driven by the dot inversion method has greater power consumption.

### SUMMARY OF THE INVENTION

Accordingly, the invention provides a display panel with high display quality and low power consumption.

The invention provides a display panel including a pixel array substrate, an opposite substrate disposed opposite to the pixel array substrate and a display medium disposed between the pixel array substrate and the opposite substrate. The pixel array substrate includes a first plate having a data signal input terminal and a scan signal input terminal, a plurality of data lines disposed on the first plate, a plurality of scan lines disposed on the first plate and a plurality of pixel units disposed on the first plate. The data lines extend along a column direction and are arranged along a row direction from the scan signal input terminal. The scan lines extend along the row direction and are arranged along the column direction from the data signal input terminal. The pixel units are arranged in at least seven columns along the row direction from the scan signal input terminal and arranged in at least three rows along the column direction from the data signal input terminal. The first data line from the scan signal input terminal is electrically connected with the pixel units arranged on the second column. The second data line from the scan signal input terminal is electrically connected with the pixel units arranged on the first and the third columns. The third data line from the scan signal input terminal is electrically connected with the pixel units arranged on the fourth and the sixth columns. The fourth data line from the scan signal input terminal is electrically connected with the pixel units arranged on the fifth and the seventh columns. The first scan line from the data signal input terminal is electrically connected with the pixel units arranged on the first, the fourth and the fifth rows of the first column. The second scan line from the data signal input terminal is electrically connected with the pixel units arranged on the second, the third, the sixth and the seventh rows of the first column. The third scan line from the data signal input terminal is electrically connected with the pixel units arranged on the first, the fourth, and the fifth rows of the second column. The fourth scan line from the data signal input terminal is electrically connected with the pixel units arranged on the second, the third, the sixth and the seventh rows of the second column. The fifth scan line from the data signal input terminal is electrically connected with the pixel units arranged on the first, the fourth and the fifth rows of the third column. The sixth scan line from the data signal input terminal is electrically connected with the pixel units arranged on the second, the third, the sixth and the seventh rows of the third column.

In an embodiment of the invention, the display panel further includes a driving unit adapted to sequentially input a plurality of scan signals to the scan lines and a plurality of data signals to the data lines. During a time period from the scan signals starting to be inputted to the first scan line to the scan signals starting to be inputted to the third scan line, the data signals inputted to the first and the third data lines have a first polarity and the data signals inputted to the second and the fourth data lines has a second polarity. During a time period from the scan signals starting to be inputted to the third scan line to the scan signals starting to be inputted to the fifth scan line, the data signals inputted to the first and third data lines has the second polarity and the data signals inputted to the second and the fourth data lines has a first polarity. During a time period of the scan signals starting to be inputted to the fifth and the sixth scan lines, the data signals inputted to the first and the third data lines has the first polarity and the data signals inputted to the second and the fourth data lines has the second polarity. The first polarity is opposite to the second polarity.

In an embodiment of the invention, the pixel units are arranged in at least ten columns along the row direction from the scan signal input terminal and arranged in at least four rows along the column direction from the data signal input terminal. The fifth data line from the scan signal input terminal is further electrically connected with the pixel units arranged on the eighth and the tenth columns. The first scan line from the data signal input terminal is further electrically connected with the pixel units arranged on the eighth and the ninth rows of the first column. The second scan line from the data signal input terminal is further electrically connected with the pixel units arranged on the tenth row of the first column. The third scan line from the data signal input terminal is further electrically connected with the pixel units arranged on the eighth and the ninth rows of the second column. The fourth scan line from the data signal input terminal is further electrically connected with the pixel units arranged on the tenth row of the second column. The fifth scan line from the data signal input terminal is further electrically connected with the pixel units arranged on the eighth and the ninth rows of the third column. The sixth scan line from the data signal input terminal is further electrically connected with the pixel units arranged on the tenth row of the third column. The seventh scan line from the data signal input terminal is further electrically connected with the pixel units arranged on the first, the fourth, the fifth, the eighth and the ninth rows of the fourth column. The eighth scan line from the data signal input terminal is further electrically connected with the pixel units arranged on the second, the third, the sixth, the seventh and the tenth rows of the fourth column.

In an embodiment of the invention, during a time period from the scan signals starting to be inputted to the first scan line to the scan signals starting to be inputted to the third scan line, the data signals inputted to the fifth data line has the first polarity. During a time period from the scan signals starting to be inputted to the third scan line to the scan signals starting to be inputted to the fifth scan line, the data signals inputted to the fifth data line has the second polarity. During a time period from the scan signals starting to be inputted to the fifth scan line to the scan signals starting to be inputted to the seventh scan line, the data signals inputted to the fifth data line has the first polarity. During a time period of the scan signals starting to be inputted to the seventh and eighth scan lines, the data signals inputted to the fifth data line has the second polarity.

In an embodiment of the invention, the first polarity is negative, and the second polarity is positive.

In an embodiment of the invention, the pixel units include active elements and pixel electrodes electrically connected with the active elements.

In an embodiment of the invention, the opposite substrate is a color filter substrate.

In an embodiment of the invention, the display medium comprises liquid crystal, an organic electroluminescence layer or electrophoresis particles.

To sum up, in the display panel according to an embodiment of the invention, the display panel is provided with advantages of high display quality and low power consumption by a special electrical connection relationship between the pixel units and the data lines and between the pixel units and the scan lines together with the adequately used data signals and scan signals.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic sectional view illustrating a display panel according to an embodiment of the invention.

FIG. 2 is a schematic top view of a pixel array substrate according to an embodiment of the invention.

FIG. 3 illustrates the scan signals inputted by the driving unit depicted in FIG. 1 to the scan lines depicted in FIG. 2.

FIG. 4 illustrates the data signals inputted by the driving unit depicted in FIG. 1 to the data lines depicted in FIG. 2.

FIG. 5 illustrates the polarities of the data signals inputted to the pixel unit depicted in FIG. 2.

### DETAILED DESCRIPTION OF DISCLOSED EMBODIMENTS

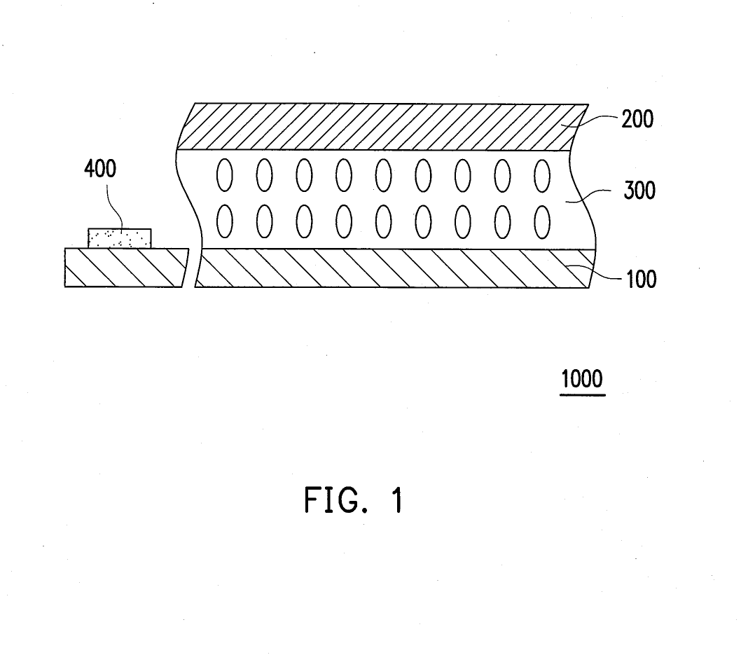

FIG. 1 is a schematic sectional view illustrating a display panel according to an embodiment of the invention. Referring to FIG. 1, a display panel 1000 of the present embodiment includes a pixel array substrate 100, an opposite substrate 200 disposed opposite to the pixel array substrate 100, and a display medium 300 disposed between the pixel array substrate 100 and the opposite substrate 200. In the present embodiment, the opposite substrate 200 is, for example, a color filter substrate, and the display medium 300 is, for example, liquid crystal. However, the invention is not limited thereto. In other embodiments, the opposite substrate 200 may be a transmissive conductive substrate without a color filter layer, and the display medium 300 may be an organic electroluminescence layer or electrophoresis particles.

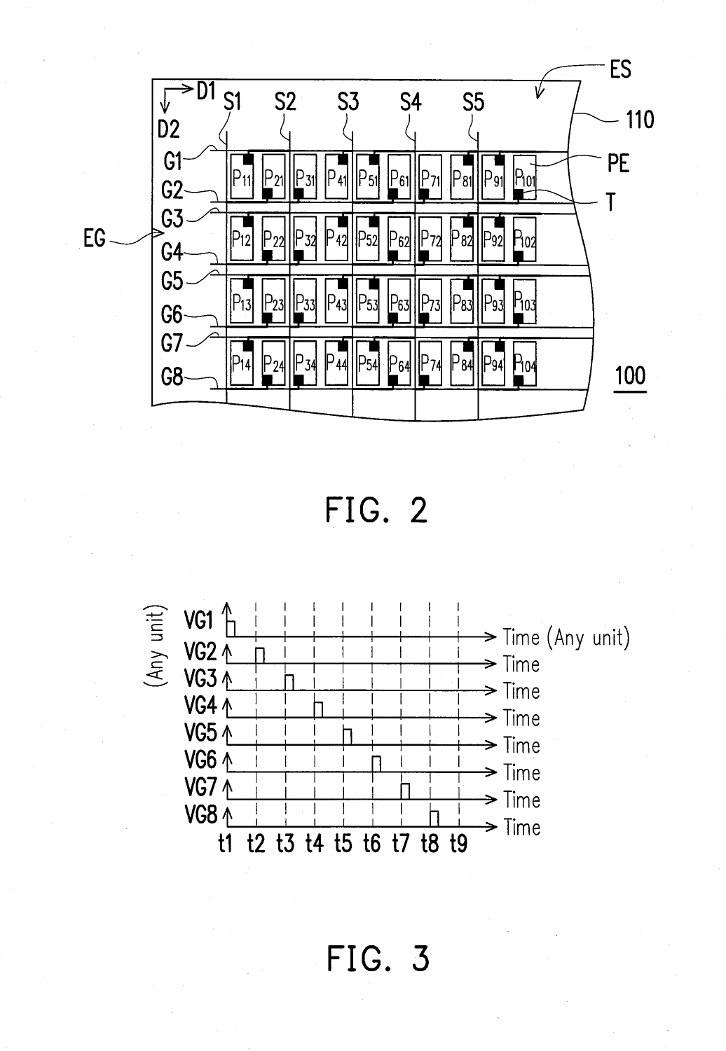

FIG. 2 is a schematic top view of the pixel array substrate according to an embodiment of the invention. Referring to FIG. 2, the pixel array substrate 100 of the present embodiment includes a first plate 110, a plurality of data lines S1˜S5 disposed on the first plate 110, a plurality of scan lines G1˜G8 disposed on the first plate 110 and a plurality of pixel units P₁₁˜P₁₀₄ disposed on the first plate 110. Each of the pixel units P₁₁˜P₁₀₄ includes an active element T having a source, a drain and a gate and a pixel electrode PE electrically connected with the drain of the active element T. The source of each active element T is electrically connected with a data line corresponding thereto. The gate of each active element T is electrically connected with a scan line corresponding thereto.

In the present embodiment, the first plate 110 is mainly configured to carry elements thereon and made of a material, such as glass, quartz, an organic polymer, an opaque/reflective material (e.g. a conductive material, a wafer or ceramics) or any other suitable material. The data lines S1˜S5 are configured to transmit data signals. The scans lines G1˜G8 are configured to transmit scan signals. The data lines S1˜S5 and the scan lines G1˜G8 are preferably made of a material having good conductivity, such as metal, alloy, metal nitride, metal oxide, metal oxynitride or a stacking layer of metal with any other conductive material.

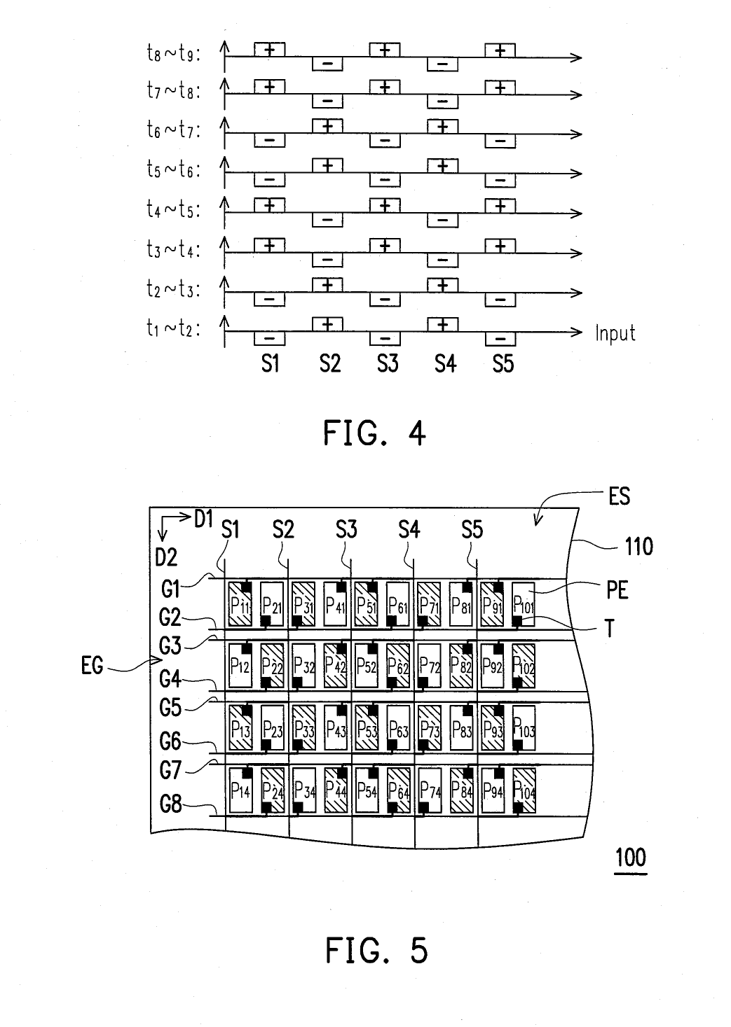

It should be mentioned that in the present embodiment, the display panel 1000 is provided with advantages of high display quality and low power consumption by a special electrical connection relationship between the pixel units P₁₁˜P₁₀₄ and the data lines S1˜S5 and between the pixel units P₁₁˜P₁₀₄ and the scan lines G1˜G8 together with the adequately used data signals and scan signals. Hereinafter, the electrical connection between the pixel units P₁₁˜P₁₀₄ and the data lines S1˜S5 and the /scan lines G1˜G8 will be described with reference to FIG. 2 first. Further, the data signals and the scan signals inputted to the scan lines G1˜G8 and the data lines S1˜S5 depicted on FIG. 2 will be described with reference to FIG. 3 and FIG. 4. Last, with reference to FIG. 5, the reasons why the display panel 1000 of the present embodiment can achieve effects of low power consumption and high display quality by the special electrical connection between the pixel units P₁₁˜P₁₀₄ and the data lines S1˜S5 and between the pixel units P₁₁˜P₁₀₄ and the scan lines G1˜G8 together with the adequately used data signals and scan signals.

First, referring to FIG. 2, the first plate 110 of the present embodiment has a data signal input terminal ES and a scan signal input terminal EG. The data signal input terminal ES and the scan signal input terminal EG are located at two adjacent sides of the first plate 110, respectively. The data lines S1˜S5 extend along a column direction D2 and are arranged along a row direction D1 from the scan signal input terminal EG. The scan lines G1˜G8 extend along the row direction D1 and are arranged along the column direction D2 from the data signal input terminal ES. The pixel units P₁₁˜P₁₀₄ are arranged in at least ten columns along the row direction D1 from the scan signal input terminal ES and arranged in at least four rows along the column direction D2 from the data signal input terminal EG.

In the present embodiment, the first data line S1 from the scan signal input terminal EG is electrically connected with the pixel units P₂₁˜P₂₄ arranged on the second column. The second data line S2 from the scan signal input terminal EG is electrically connected with the pixel units P₁₁˜P₁₄ and P₃₁˜P₃₄ arranged on the first and the third columns. The third data line S3 from the scan signal input terminal EG is electrically connected with the pixel units P₄₁˜P₄₄ and P₆₁˜P₆₄ arranged on the fourth and the sixth columns The fourth data line S4 from the scan signal input terminal EG is electrically connected with the pixel units P₅₁˜P₅₄ and P₇₁˜P₇₄ arranged on the fifth and the seventh columns. The fifth data line S5 from the scan signal input terminal EG is electrically connected with the pixel units P₈₁˜P₈₄ and P₁₀₁˜P₁₀₄ arranged on the eighth and the tenth columns. Thus, the electrical connection between the n^{th} (n is a positive integer greater than or equal to 6) data line from the scan signal input terminal EG and the pixel units may be inferred from the above, and will not be repeated one by one hereinafter.

In the present embodiment, the first scan line G1 from the data signal input terminal ES is electrically connected with the pixel units P₁₁, P₄₁, P₅₁, P₈₁ and P₉₁ arranged on the first, the fourth, the fifth, the eighth and the ninth rows of the first column. The second scan line G2 from the data signal input terminal ES is electrically connected with the pixel units P₂₁, P₃₁, P₆₁, P₇₁ and P₁₀₁ arranged on the second, the third, the sixth, the seventh and the tenth rows of the first column. The third scan line G3 from the data signal input terminal ES is electrically connected with the pixel units P₁₂, P₄₂, P₅₂, P₈₂ and P₉₂ arranged on the first, the fourth, the fifth, the eighth and the ninth rows of the second column. The fourth scan line G4 from the data signal input terminal ES is electrically connected with the pixel units P₂₂, P₃₂, P₆₂, P₇₂ and P₁₀₂ arranged on the second, the third, the sixth, the seventh and the tenth rows of the second column. The fifth scan line G5 from the data signal input terminal ES is electrically connected with the pixel units P₁₃, P₄₃, P₅₃, P₈₃ and P₉₃ arranged on the first, the fourth, the fifth, the eighth and the ninth rows of the third column. The sixth scan line G6 from the data signal input terminal ES is electrically connected with the pixel units P₂₃, P₃₃, P₆₃, P₇₃ and P₁₀₃ arranged on the second, the third, the sixth, the seventh and the tenth rows of the third column. The seventh scan line G7 from the data signal input terminal ES is electrically connected with the pixel units P₁₄, P₄₄, P₅₄, P₈₄ and P₉₄ arranged on the first, the fourth, the fifth, the eighth and the ninth rows of the fourth column. The eighth scan line G8 from the data signal input terminal ES is electrically connected with the pixel units P₂₄, P₃₄, P₆₄, P₇₄ and P₁₀₄ arranged on the second, the third, the sixth, the seventh and the tenth rows of the fourth column. Thus, the electrical connection between the m^{th} (m is a positive integer greater than or equal to 9) scan line from the data signal input terminal ES and the pixel units may be inferred from the above, and will not be repeated one by one hereinafter.

Referring to FIG. 1 again, the display panel 1000 of the present embodiment further includes a driving unit 400. The driving unit 400 is electrically connected with the scan lines and the data lines. The driving unit 400 is adapted to sequentially input scan signals to the scan lines G1˜G8 and input data signals to the data lines S1˜S5. In the present embodiment, the driving unit 400 is, for example, a chip bounded on the first plate 100.

FIG. 3 illustrates the scan signals inputted by the driving unit depicted in FIG. 1 to the scan lines depicted in FIG. 2. FIG. 4 illustrates the data signals inputted by the driving unit depicted in FIG. 1 to the data lines depicted in FIG. 2. As shown in FIG. 2 and FIG. 3, during a time period from a scan signal VG1 starting to be inputted to the first scan line G1 to a scan signal VG2 starting to be inputted to the second scan line G2 (i.e. during a time period from a time point t1 to a time point t2), as shown on the bottom line of FIG. 4, at this time, the data signals VS inputted to the first, the third and the fifth data lines S1, S3 and S5 has a first polarity, and the data signals VS inputted to the second and the fourth data lines S2 and S4 has a second polarity. The first polarity is opposite to the second polarity. In the present embodiment, the first polarity is, for example, negative, and the second polarity is, for example, positive. However, the invention is not limited thereto. In other embodiments, the first polarity may also be positive, and the second polarity may also be negative.

FIG. 5 illustrates the polarities of the data signals inputted to the pixel unit depicted in FIG. 2. Specifically, in FIG. 5, the pixel unit filled with slashes represent that the polarity of the data signal inputted thereto is positive, and the pixel unit in blank represent that the polarity of the data signal inputted thereto is negative. Referring to FIG. 2, FIG. 3, FIG. 4 and FIG. 5 simultaneously, during the time period of the scan signal VG1 being inputted to the first scan line G1 (i.e. during the time period from the time point t1 to the time point t2), the data signals VS shown on the bottom line of FIG. 4 are inputted to the pixel units P₁₁, P₄₁, P₅₁, P₈₁ and P₉₁ arranged on the first, the fourth, the fifth, the eighth and the ninth rows of the first column. At this time, as shown in FIG. 5, the data signals VS inputted to the pixel units P₁₁, P₄₁, P₅₁ and P₈₁ have the polarities as positive, negative, positive, and negative, respectively.

As shown in FIG. 2 and FIG. 3, during a time period from the scan signal VG2 starting to be inputted to the second scan line G2 to a scan signal VG3 starting to be inputted to the third scan line G3 (i.e. during a time period from the time point t2 to a time point t3). As shown on the second line from the bottom of FIG. 4, at this time, the data signals VS inputted to the first, the third and the fifth data lines S1, S3 and S5 have the negative polarity, and the data signals VS inputted to the second and the fourth data lines S2 and S4 have the positive polarity. Referring to FIG. 2, FIG. 3, FIG. 4 and FIG. 5 simultaneously, during the time period of the scan signal VG2 being inputted to the second scan line G2 (i.e. at the time period from the time point t2 to the time point t3), the data signals VS shown on the second line from the bottom of FIG. 4 are inputted to the pixel units P₂₁, P₃₁, P₆₁, P₇₁ and P₁₀₁ arranged on the second, the third, the sixth, the seventh and the tenth rows of the first column. At this time, as shown in FIG. 5, the data signals VS inputted to the pixel units P₂₁, P₃₁, P₆₁, P₇₁ and Pᵢₒᵢ have the polarities as negative, positive, negative, positive and negative, respectively.

As shown in FIG. 2 and FIG. 3, during a time period from the scan signal VG3 starting to be inputted to the third scan line G3 to a scan signal VG4 starting to be inputted to the fourth scan line G4 (i.e. during a time period from the time point t3 to a time point t4). As shown on the third line from the bottom of FIG. 4, at this time, the data signals VS inputted to the first, the third and the fifth data lines S1, S3 and S5 have the positive polarity, and the data signals VS inputted to the second and the fourth data lines S2 and S4 have the negative polarity. Referring to FIG. 2, FIG. 3, FIG. 4 and FIG. 5 simultaneously, during the time period from the scan signal VG3 starting to be inputted to the third scan line G3 to the scan signal VG4 starting to be inputted to the fourth scan line G4 (i.e. during the time period from the time point t3 to the time point t4), the data signals VS shown on the third line from the bottom of FIG. 4 are inputted to the pixel units P₁₂, P₄₂, P₅₂, P₈₂ and P₉₂ arranged on the first, the fourth, the fifth, the eighth and the ninth rows of the second column. At this time, as shown in FIG. 5, the data signals VS inputted to the pixel units P₁₂, P₄₂, P₅₂, and P₈₂ the polarities as negative, positive, negative, and positive, respectively.

As shown in FIG. 2 and FIG. 3, during a time period from the scan signal VG4 starting to be inputted to the fourth scan line G4 to a scan signal VG5 starting to be inputted to the fifth scan line G5 (i.e. during a time period from the time point t4 to a time point t5), as shown on the fourth line from the bottom of FIG. 4, at this time, the data signals VS inputted to the first, the third and the fifth data lines S1, S3 and S5 have the positive polarity, and the data signals VS inputted to the second and the fourth data lines S2 and S4 have the negative polarity. Referring to FIG. 2, FIG. 3, FIG. 4 and FIG. 5 simultaneously, during the time period from the scan signal VG4 starting to be inputted to the fourth scan line G4 to the scan signal VG5 starting to be inputted to the fifth scan line G5 (i.e. during the time period from the time point t4 to the time point t5), the data signals VS shown on the fourth line from the bottom of FIG. 4 are inputted to the pixel units P₂₂, P₃₂, P₆₂, P₇₂ and P₁₀₂ arranged on the second, the third, the sixth, the seventh and the tenth rows of the second column. At this time, as shown in FIG. 5, the data signals VS inputted to the pixel units P₂₂, P₃₂, P₆₂, P₇₂ and P₁₀₂ have the polarities as positive, negative, positive, negative and positive, respectively.

As shown in FIG. 2 and FIG. 3, during a time period from the scan signal VG5 starting to be inputted to the fifth scan line G5 to a scan signal VG6 starting to be inputted to the sixth scan line G6 (i.e. during a time period from the time point t5 to a time point t6), as shown on the fifth line from the bottom of FIG. 4, at this time, the data signals VS inputted to the first, the third and the fifth data lines S1, S3 and S5 have the negative polarity, and the data signals VS inputted to the second and the fourth data lines S2 and S4 have the positive polarity. Referring to FIG. 2, FIG. 3, FIG. 4 and FIG. 5 simultaneously, during the time period from the scan signal VG5 starting to be inputted to the fifth scan line G5 to the scan signal VG6 starting to be inputted to the sixth scan line G6 (i.e. during the time period from the time point t5 to the time point t6), the data signals VS shown on the fifth line from the bottom of FIG. 4 are inputted to the pixel units P₁₃, P₄₃, P₅₃, P₈₃ and P₉₃ arranged on the first, the third, the fifth, the eighth and the ninth rows of the third column. At this time, as shown in FIG. 5, the data signals VS inputted to the pixel units P₁₃, P₄₃, P₅₃, and P₈₃ have the polarities as positive, negative, positive, and negative, respectively.

As shown in FIG. 2 and FIG. 3, during a time period from the scan signal VG6 starting to be inputted to the sixth scan line G6 to a scan signal VG7 starting to be inputted to the seventh scan line G7 (i.e. during a time period from the time point t6 to a time point t7), as shown on the third line from the top of FIG. 4, at this time, the data signals VS inputted to the first, the third and the fifth data lines S1, S3 and S5 have the negative polarity, and the data signals VS inputted to the second and the fourth data lines S2 and S4 have the positive polarity. Referring to FIG. 2, FIG. 3, FIG. 4 and FIG. 5 simultaneously, during the time period from the scan signal VG6 starting to be inputted to the sixth scan line G6 to the scan signal VG7 starting to be inputted to the seventh scan line G7 (i.e. during the time period from the time point t6 to the time point t7), the data signals VS shown on the third line from the top of FIG. 4 are inputted to the pixel units P₂₃, P₃₃, P₆₃, P₇₃ and P₁₀₃ arranged on the second, the third, the sixth, the seventh and the tenth rows of the third column. At this time, as shown in FIG. 5, the data signals VS inputted to the pixel units P₂₃, P₃₃, P₆₃, P₇₃ and P₁₀₃ have the polarities as negative, positive, negative, positive and negative, respectively.

As shown in FIG. 2 and FIG. 3, during a time period from the scan signal VG7 starting to be inputted to the seventh scan line G7 to a scan signal VG8 starting to be inputted to the eighth scan line G8 (i.e. during a time period from the time point t7 to a time point t8), as shown on the second line from the top of FIG. 4, at this time, the data signals VS inputted to the first, the third and the fifth data lines S1, S3 and S5 have the positive polarity, and the data signals VS inputted to the second and the fourth data lines S2 and S4 have the negative polarity. Referring to FIG. 2, FIG. 3, FIG. 4 and FIG. 5 simultaneously, during the time period from the scan signal VG7 starting to be inputted to the seventh scan line G7 to the scan signal VG8 starting to be inputted to the eighth scan line G8 (i.e. during the time period from the time point t7 to the time point t8), the data signals VS shown on the second line from the top of FIG. 4 are inputted to the pixel units P₁₄, P₄₄, P₅₄, P₈₄ and P₉₄ arranged on the first, the fourth, the fifth, the eighth and the ninth rows of the fourth column. At this time, as shown in FIG. 5, the data signals VS inputted to the pixel units P₁₄, P₄₄, P₅₄, and P₈₄ have the polarities as negative, positive, negative, and positive, respectively.

As shown in FIG. 2 and FIG. 3, during a time period from the scan signal VG8 starting to be inputted to the eighth scan line G8 to a scan signal VG9 starting to be inputted to the ninth scan line G9 (i.e. during a time period from the time point t8 to a time point t9), as shown on the first line from the top of FIG. 4, at this time, the data signals VS inputted to the first, the third and the fifth data lines S1, S3 and S5 have the positive polarity, and the data signals VS inputted to the second and the fourth data lines S2 and S4 have the negative polarity. Referring to FIG. 2, FIG. 3, FIG. 4 and FIG. 5 simultaneously, during the time period from the scan signal VG8 starting to be inputted to the eighth scan line G8 to the scan signal VG9 starting to be inputted to the ninth scan line G9 (i.e. during the time period from the time point t8 to the time point t9), the data signals VS shown on the first line from the top of FIG. 4 are inputted to the pixel units P₂₄, P₃₄, P₆₄, P₇₄ and P₁₀₄ arranged on the second, the third, the sixth, the seventh and the tenth rows of the fourth column. At this time, as shown in FIG. 5, the data signals VS inputted to the pixel units P₂₄, P₃₄, P₆₄, P₇₄ and P₁₀₄ have the polarities as positive, negative, positive, negative and positive, respectively.

Based on the above and FIG. 5, when the electrical connection relationship between the pixel units P₁₁˜P₁₀₄ of the display panel 1000 and the data lines S1˜S5 and the scan lines G1˜G8 are as illustrated in FIG. 2, and the scan signals and the data signals as depicted in FIG. 3 and FIG. 4 are used by the display panel 1000, each pixel unit has the polarity opposite to its adjacent pixel unit. In other words, by the electrical connection relationship between the pixel units and the data lines and between the pixel units and the scan lines as shown in FIG. 2 together with the scan signals and the data signals as shown in FIG. 3 and FIG. 4, a screen displayed by the display panel 1000 can have the dot inversion property without occurring abnormal problems such as flicking or cross talk and thus, has high display quality. In addition, it can be learned from FIG. 4 that as for the same data line (e.g. the data line S1), the polarity of the data signals VS inputted therein is changed only once after two scan time periods (a scan time period is a time period from a time point tk to a time point tk+1, where k is a positive integer greater than or equal to 1). In other words, in the present embodiment, the polarity of the data signals VS inputted to the same data line is not changed less frequently than the dot inversion of the related art (in the dot inversion technique of the related art, the polarity of the data signals VS inputted to the same data line is changed per scan time period. Therefore, the display panel 1000 of the present embodiment can have advantages of both high display quality and low power consumption.

Accordingly, in the display panel according to an embodiment of the invention, the display panel is provided with advantages of high display quality and low power consumption by a special electrical connection relationship among the pixel units, the data lines and the scan lines together with the adaptive data signals and scan signals.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A display panel, comprising:
a pixel array substrate, comprising:
a first plate, having a data signal input terminal and a scan signal input terminal;
a plurality of data lines, disposed on the first plate, extending along a column direction and arranged along a row direction from the scan signal input terminal;
a plurality of scan lines, disposed on the first plate, extending along the row direction and arranged along the column direction from the data signal input terminal; and
a plurality of pixel units, disposed on the first plate, arranged in at least seven columns along the row direction from the scan signal input terminal and arranged in at least three rows along the column direction from the data signal input terminal, wherein the first data line from the scan signal input terminal is electrically connected with the pixel units arranged on the second column, the second data line from the scan signal input terminal is electrically connected with the pixel units arranged on the first and the third columns, the third data line from the scan signal input terminal is electrically connected with the pixel units arranged on the fourth and the sixth columns, the fourth data line from the scan signal input terminal is electrically connected with the pixel units arranged on the fifth and the seventh columns, the first scan line from the data signal input terminal is electrically connected with the pixel units arranged on the first, the fourth and the fifth rows of the first column, the second scan line from the data signal input terminal is electrically connected with the pixel units arranged on the second, the third, the sixth and the seventh rows of the first column, the third scan line from the data signal input terminal is electrically connected with the pixel units arranged on the first, the fourth, and the fifth rows of the second column, the fourth scan line from the data signal input terminal is electrically connected with the pixel units arranged on the second, the third, the sixth and the seventh rows of the second column, the fifth scan line from the data signal input terminal is electrically connected with the pixel units arranged on the first, the fourth and the fifth rows of the third column, and the sixth scan line from the data signal input terminal is electrically connected with the pixel units arranged on the second, the third, the sixth and the seventh rows of the third column;
an opposite substrate, disposed opposite to the pixel array substrate; and
a display medium, disposed between the pixel array substrate and the opposite substrate.

2. The display panel according to claim 1, further comprising a driving unit adapted to sequentially input a plurality of scan signals to the plurality of scan lines and a plurality of data signals to the plurality of data lines, wherein during a time period from the scan signals starting to be inputted to the first scan line to the scan signals starting to be inputted to the third scan line, the data signals inputted to the first and the third data lines have a first polarity and the data signals inputted to the second and the fourth data lines has a second polarity, during a time period from the scan signals starting to be inputted to the third scan line to the scan signals starting to be inputted to the fifth scan line, the data signals inputted to the first and the third data lines has the second polarity and the data signals inputted to the second and the fourth data lines has the first polarity, and during a time period of the scan signals starting to be inputted to the fifth and the sixth scan lines, the data signals inputted to the first and the third data lines has the first polarity and the data signals inputted to the second and the fourth data lines has the second polarity, wherein the first polarity is opposite to the second polarity.

3. The display panel according to claim 2, wherein the pixel units are arranged in at least ten columns along the row direction from the scan signal input terminal and arranged in at least four rows along the column direction from the data signal input terminal, wherein the fifth data line from the scan signal input terminal is further electrically connected with the pixel units arranged on the eighth and the tenth columns, the first scan line from the data signal input terminal is further electrically connected with the pixel units arranged on the eighth and the ninth rows of the first column, the second scan line from the data signal input terminal is further electrically connected with the pixel units arranged on the tenth row of the first column, the third scan line from the data signal input terminal is further electrically connected with the pixel units arranged on the eighth and the ninth rows of the second column, the fourth scan line from the data signal input terminal is further electrically connected with the pixel units arranged on the tenth row of the second column, the fifth scan line from the data signal input terminal is further electrically connected with the pixel units arranged on the eighth and the ninth rows of the third column, the sixth scan line from the data signal input terminal is further electrically connected with the pixel units arranged on the tenth row of the third column, the seventh scan line from the data signal input terminal is further electrically connected with the pixel units arranged on the first, the fourth, the fifth, the eighth and the ninth rows of the fourth column, and the eighth scan line from the data signal input terminal is further electrically connected with the pixel units arranged on the second, the third, the sixth, the seventh and the tenth rows of the fourth column.

4. The display panel according to claim 3, wherein during a time period from the scan signals starting to be inputted to the first scan line to the scan signals starting to be inputted to the third scan line, the data signals inputted to the fifth data line has the first polarity, during a time period from the scan signals starting to be inputted to the third scan line to the scan signals starting to be inputted to the fifth scan line, the data signals inputted to the fifth data line has the second polarity, during a time period from the scan signals starting to be inputted to the fifth scan line to the scan signals starting to be inputted to the seventh scan line, the data signals inputted to the fifth data line has the first polarity, and during a time period of the scan signals starting to be inputted to the seventh and eighth scan lines, the data signals inputted to the fifth data line has the second polarity.

5. The display panel according to claim 2, wherein the first polarity is negative, and the second polarity is positive.

6. The display panel according to claim 1, wherein each of the pixel units comprises an active element and a pixel electrode electrically connected with the active element.

7. The display panel according to claim 1, wherein the opposite substrate is a color filter substrate.

8. The display panel according to claim 1, wherein the display medium comprises liquid crystal, an organic electroluminescence layer or electrophoresis particles.
